(19) United States
(12) Patent Application Publication
(10) Pub. No.: US 2026/0175533 A1
(43) Pub. Date: Jun. 25, 2026

(54) ADJUSTABLE BLOCK FOR A CONTINUOUS PANEL MANUFACTURING LINE AND METHOD OF MANUFACTURING INSULATED PANELS

(71) Applicant: Nucor Insulated Panel Group, LLC, Wilmington, DE (US)

(72) Inventors: Jeffrey William Carper, Prince George, VA (US); Christopher Ronald Hardy, Dinwiddie, VA (US); Shaun Michael Shaw, Wakefield, VA (US); Todd Lavelley, Prince George, VA (US)

(73) Assignee: Nucor Insulated Panel Group, LLC, Wilmington, DE (US)

(21) Appl. No.: 19/405,699

(22) Filed: Dec. 2, 2025

Related U.S. Application Data
(60) Provisional application No. 63/729,624, filed on Dec. 9, 2024.

(51) Int. Cl. B32B 5/18; E04B 1/14; E04C 2/22; E04C 2/38; E04F 13/08

(52) U.S. Cl. CPC B32B 5/18; E04B 1/14; E04C 2/22; E04C 2/384; E04F 13/0889

(57) ABSTRACT

Insulated panel manufacturing that utilizes adjustable blocks for forming insulated panels having different thicknesses without having to change out the blocks every time insulated panels having different thicknesses are being manufactured. The adjustable blocks have a first block portion and a second block portion that move with respect to each other through the use of a biasing assembly that can be compressed and expanded to allow for forming of insulated panels having different thicknesses.

### CROSS REFERENCE AND PRIORITY CLAIM UNDER 35 U.S.C. § 119

This application claims priority to U.S. Provisional Application No. 63/729,624 entitled “Adjustable Block for a Continuous Panel Manufacturing Line and Method of Manufacturing Insulted Panels” filed on Dec. 9, 2024, which is assigned to the assignee hereof and the entirety of which is incorporated by reference herein.

### FIELD

This application relates generally to the field of insulated panels for buildings, and more particularly, to improved manufacturing of insulated panels utilizing adjustable blocks within a continuous panel manufacturing line.

### BACKGROUND

Current manufacturing of insulated panels may be time consuming based on the types of insulated panels being produced. There is a need for providing improved manufacturing of insulated panels.

### BRIEF SUMMARY

Embodiments of the present disclosure relate to improved insulated panel manufacturing that utilizes adjustable blocks for forming insulated panels having different thicknesses without having to change out the blocks every time insulated panels having a different thickness are being manufactured. The adjustable blocks have a first block portion and a second block portion that move with respect to each other through the use of a biasing assembly that can be compressed and expanded to allow for forming of insulated panels having different thicknesses.

One embodiment of the disclosure is a continuous insulated panel manufacturing apparatus. The apparatus comprises a first substrate supply assembly configured to supply a first substrate, and a second substrate supply assembly configured to supply a second substrate. The apparatus further comprises an insulation applicator configured to distribute unexpanded insulation material between the first substrate and the second substrate that expands after distribution between the first substrate and the second substrate. Furthermore, the apparatus comprises a laminator assembly comprising one or more heater assemblies configured to heat the first substrate, the second substrate and expanded insulation material therebetween, one or more edge mold assemblies having a plurality of adjustable blocks configured to form edges of an insulated panel, and one or more laminator adjustment assemblies configured to adjust the plurality of adjustable blocks to set the thickness of the insulated panel.

In further accord with embodiments, the adjustable block of the plurality of adjustable blocks comprise a first block portion with one or more first projections, a second block portion with one or more second projections, and a biasing assembly configured to allow at least one of the first block portion or second block portion to move with respect to the other to adjust the distance between the one or more first projections and the one or more second projections. The adjustable block is configured to form a portion of a proximal edge or a distal edge of an insulated panel and define a thickness of the insulated panel.

In other embodiments, the biasing assembly comprises one or more bearings operatively coupled to the first block portion or the second block portion, one or more bearing projections operatively coupled to the first block portion or the second block portion, and one or biasing members operatively coupled to the first block portion, the second block portion, the one or more bearings, or the one or more bearing projections.

In yet other embodiments, the one or more biasing members comprise one or more compression springs, wherein the one or more bearing projections comprise one or more guide pins, and wherein the one or more bearings comprise one or more cylindrical bearings.

In still other embodiments, the one or more bearing projections extend within the one or more bearings, and the one or more compression springs extend around the one or more bearings and the one or more bearing projections or wherein the one or more bearing projections extend around the one or more bearings, and the one or more compression springs extend around the one or more bearings and the one or more bearing projections.

Another embodiment of the disclosure is an adjustable block configured to be used in a continuous insulated panel manufacturing apparatus. The adjustable block comprises a first block portion with one or more first edge projections, a second block portion with one or more second edge projections, and a biasing assembly configured to allow at least one of the first block portion or second block portion to move with respect to the other to adjust the distance between the one or more first edge projections and the one or more second edge projections. The adjustable block is configured to form a portion of a proximal edge or a distal edge of an insulated panel and define a thickness of the insulated panel.

In further accord with embodiments, the biasing assembly comprises one or more bearings operatively coupled to the first block portion or the second block portion, one or more bearing projections operatively coupled to the first block portion or the second block portion, and one or biasing members operatively coupled to the first block portion, the second block portion, the one or more bearings, or the one or more bearing projections.

In other embodiments, the one or more biasing members comprise one or more compression springs.

In still other embodiments, the one or more bearing projections comprise one or more guide pins.

In yet other embodiments, the one or more bearings comprise one or more cylindrical bearings.

In other embodiments, the one or more bearing projections extend within the one or more bearings, and the one or more biasing members extend around the one or more bearings and the one or more bearing projections.

In still other embodiments, the one or more bearing projections extend around the one or more bearings, and the one or more biasing members extend around the one or more bearings and the one or more bearing projections.

In further accord with embodiments, the biasing assembly comprises two bearings operatively coupled to the first block portion, and two bearing projections operatively coupled to the second block portion.

In other embodiments, the biasing assembly comprises a first bearing and a first bearing projection operatively coupled to the first block portion, and a second bearing and a second bearing projection operatively coupled to the second block portion.

In still other embodiments, the first block portion or the second block portion comprise one or more alignment connectors to aid in the adjustment of the first portion with the second block portion.

In yet other embodiments, the one or more alignment connectors comprise one or more extending alignment projections of the first block portion or the second block portion, and one or more receiving alignment cavities in the opposite of the first block portion or the second block portion. The one or more extending alignment projections slide within the one or more receiving alignment cavities.

In other embodiments, the one or more first block edge projections of the first block portion comprise a primary first block edge projection, a secondary first block edge projection, and a first block edge cavity formed from the primary first block edge projection and the secondary first block edge projection.

In still other embodiments, the one or more second block edge projections of the second block portion comprise a primary second block edge projection, a secondary second block edge projection, and a second block edge cavity formed from the primary second block edge projection and the secondary second block edge projection.

Another embodiment of the invention is a method of forming one or more insulated panels. The method comprises distributing unexpanded insulation material between a first substrate and a second substrate that expands between the first substrate and the second substrate. The method further comprises heating the first substrate, the second substrate, and expanded insulation material therebetween. The method also comprises adjusting a plurality of adjustable blocks to form the insulated panel with a thickness based on an adjustment of the plurality of adjustable blocks.

In further accord with embodiments, the adjustable block comprises a first block portion with one or more first edge projections, a second block portion with one or more second edge projections, and a biasing assembly configured to allow at least one of the first block portion or second block portion to move with respect to the other to adjust the distance between the one or more first edge projections and the one or more second edge projections. The adjustable block is further configured to form a portion of a proximal edge or a distal edge of an insulated panel and define the thickness of the insulated panel.

To the accomplishment of the foregoing and the related ends, the one or more embodiments of the invention comprise the features hereinafter fully described and particularly pointed out in the claims. The following description and the annexed drawings set forth certain illustrative features of the one or more embodiments. These features are indicative, however, of but a few of the various ways in which the principles of various embodiments may be employed, and this description is intended to include all such embodiments and their equivalents.

### BRIEF DESCRIPTION OF DRAWINGS

The accompanying drawings illustrate some of the embodiments of the invention and are not necessarily drawn to scale, wherein:

FIG. 1 illustrates a perspective view of a barrier system having a plurality of barrier panels installed on support members, in accordance with embodiments of the present disclosure;

FIG. 2A illustrates a front perspective view of a heavy gauge barrier panel being installed on an I-beam support member, in accordance with embodiments of the present disclosure;

FIG. 2B illustrates a rear perspective view of the heavy gauge barrier panel of FIG. 2A that also utilizes a rear connection, in accordance with embodiments of the present disclosure;

FIG. 3A illustrates a front perspective view of a light gauge barrier panel being installed on an z-shaped support member, in accordance with embodiments of the present disclosure;

FIG. 3B illustrates a rear perspective view of the light gauge barrier panel of FIG. 3A that also utilizes a rear connection, such as a rivets, in accordance with embodiments of the present disclosure;

FIG. 4A illustrates an end view of an insulated panel, in accordance with embodiments of the present disclosure;

FIG. 4B illustrates a cross-sectional view of a first insulated panel being assembled with a second insulated panel along the edges, in accordance with embodiments of the present disclosure;

FIG. 4C illustrates a cross-sectional view of first and second insulated panels assembled along the edges, in accordance with embodiments of the present disclosure;

FIG. 5A illustrates a perspective and enlarged view of a flat phase-change insulated panel, in accordance with embodiments of the present disclosure;

FIG. 5B illustrates a perspective and enlarged view of a striated phase-change insulated panel, in accordance with embodiments of the present disclosure;

FIG. 5C illustrates a perspective and enlarged view of a corrugated phase-change insulated panel, in accordance with embodiments of the present disclosure;

FIG. 6A illustrates a schematic diagram of a continuous panel manufacturing line with a laminator, in accordance with embodiments of the present disclosure;

FIG. 6B illustrates a perspective view of a portion of a continuous panel manufacturing line, in accordance with embodiments of the present disclosure;

FIG. 6C illustrates a perspective view of a portion of a continuous panel manufacturing line, in accordance with embodiments of the present disclosure;

FIG. 7A illustrates a perspective view of a static applicator dispensing a liquid insulation material, in accordance with embodiments of the present disclosure;

FIG. 7B illustrates a perspective view of the insulation applicator dispensing a foam insulation material, in accordance with embodiments of the present disclosure;

FIG. 7C illustrates the insulation material expanding in the liner entry before the laminator, in accordance with embodiments of the present disclosure;

FIG. 7D illustrates a perspective side view of the laminator, in accordance with embodiments of the present disclosure;

FIG. 7E illustrates a perspective end view of the laminator, in accordance with embodiments of the present disclosure;

FIG. 8A illustrates a perspective view of an adjustable block in the fully compressed position, in accordance with embodiments of the present disclosure;

FIG. 8B illustrates a perspective view of an adjustable block in the fully expanded position, in accordance with embodiments of the present disclosure;

FIG. 8C illustrates the perspective view of the adjustable block of FIG. 8B with the biasing assembly at least partially exposed, in accordance with embodiments of the present disclosure;

FIG. 9 illustrates a first portion of the adjustable block, in accordance with embodiments of the present disclosure;

FIG. 10 illustrates a second portion of the adjustable block, in accordance with embodiments of the present disclosure;

FIG. 11A illustrates a guide pin of the adjustable block, in accordance with embodiments of the present disclosure;

FIG. 11B illustrates a bearing of the adjustable block, in accordance with embodiments of the present disclosure;

FIG. 11C illustrates a biasing member of the adjustable block, in accordance with embodiments of the present disclosure;

FIG. 12 illustrates a perspective view of a first portion and a second portion of an adjustable block, in accordance with embodiments of the present disclosure; and

FIG. 13 illustrates a process for manufacturing insulated panels using the continuous insulated manufacturing equipment with the adjustable block, in accordance with embodiments of the present disclosure.

### DETAILED DESCRIPTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

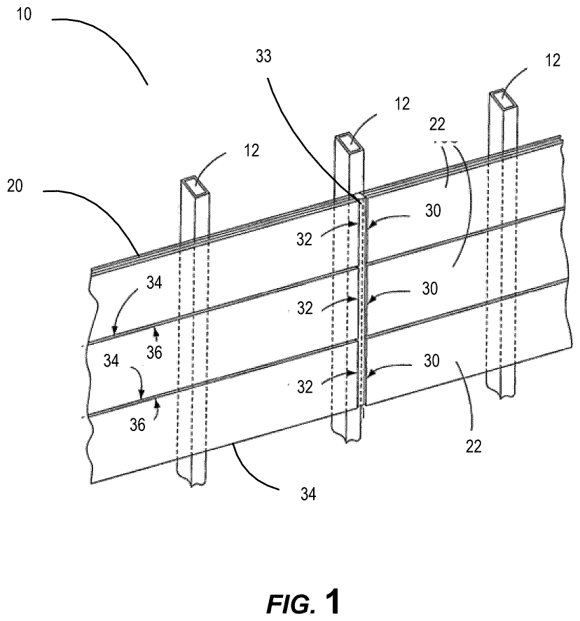

FIG. 1 illustrates a portion of building envelope system 10. The building envelope system 10 includes support members 12 (e.g., vertical support members, such as studs, I-beams, z-channels, or the like made of any material), which are structurally connected to other building support members (e.g., floors, girders, joists, or the like) directly or indirectly. A barrier panel system having barrier panels may be attached to the support members 12 to provide one or more benefits, such as air, water, vapor, and/or thermal protection. In some embodiments of the present invention, the barrier system is an insulated panel system 20 that uses insulated panels to provide thermal protection. In particular embodiments of the present disclosure, the insulated panel system 20 utilizes a plurality of insulated panels 22, as will be described in further detail herein. In some embodiments an exterior system (not illustrated) may be attached to the outer surface of the barrier system via an exterior panel connector.

As illustrated in FIGS. 1 through 5C, the insulated panels 22 may have substrates (otherwise described as faces, skins, or the like), such as a first substrate 24 (e.g., first face, first skin, or the like), and a second substrate 26 (e.g., second face, second skin, or the like). It should be understood that the first substrate 24 may be the exterior face and the second substrate 26 may be interior face; however, the second substrate 26 may be the exterior face and the first substrate 24 may be the interior face. The first substrate 24 and/or the second substrate 26 are typically made from steel, such as G90 galvanized steel, for structural strength purposes and to resist corrosion. However, other types of steels, other metallic materials, and/or combinations of materials, such as aluminum and other similar materials, are also contemplated for the substrates 24, 26. Moreover, the insulated panels 22 may have ends, such as a first end 30 (e.g., left end, proximal end, or the like) and a second end 32 (e.g., right end, distal end, or the like), and edges, such as a first edge 34 (e.g., a lower edge, proximal edge, or the like) and a second edge 36 (e.g., upper edge, distal edge, or the like). As illustrated in FIG. 1, multiple insulated panels 22 may be installed (e.g., such as adjacent the floor, base, or the like) of a building onto one or more support members 12 to form an insulated panel system 20. The insulated panel(s) 22 may extend over two or more support members 12. As illustrated in FIG. 1, a first end 30 of a first panel 22 may butt up to a second end 32 of a second panel 22 (e.g., horizontally end to end). As illustrated in FIG. 1, the ends 30, 32 of adjacent panels 22 may butt up to each other at the locations of a support member 12. However, it should be understood that the ends 30, 32 of adjacent panels 22 may butt up to each other at locations between support members 12. While the ends 30, 32 of the panels 22 are illustrated as butting up to each other, in some embodiments, the ends 30, 32 of the panels 22 may at least partially overlap. Moreover, in some embodiments end connectors (e.g., fasteners, clips, or the like) may be used to operatively coupled the ends 30, 32 of adjacent panels together. Alternatively, or additionally, a seal 33 (e.g., gasket seal, adhesive, caulk, or the like) may be located between a portion of adjacent panels 22, such as at the ends 30, 32 of the panels 22, as illustrated in FIG. 1.

As further illustrated in FIGS. 1 through 5C, multiple panels 20 may be assembled on top of each other using the edges 34, 36 of the panels 20. For example, as illustrated in FIG. 1, a first edge 34 of one panel 22 may be operatively coupled to a second edge 36 of an adjacent panel 22 (e.g., vertically edge to edge). As illustrated in FIGS. 1 through 5C, the edges 34, 36 of the panels 22 may have one or more projections 40 that form one or more cavities 42 on one or both edges 34, 36 of the panels 22. The one or more projections 40 and one or more cavities 42 are used to interlock a first edge 34 of a first panel 22 with a second edge 36 of an adjacent second panel 22. The interlocking of the edges 34, 36 creates and/or improves (e.g., reduces or eliminates) the passage of air, water, vapors, heat, or the like between the edges 34, 36 of the adjacent panels 22. The interlocking edges 34, 36 and the thickness may be determined by (e.g., formed by, or the like) the adjustable blocks 300 within the laminator 160, as will be described in further detail herein below.

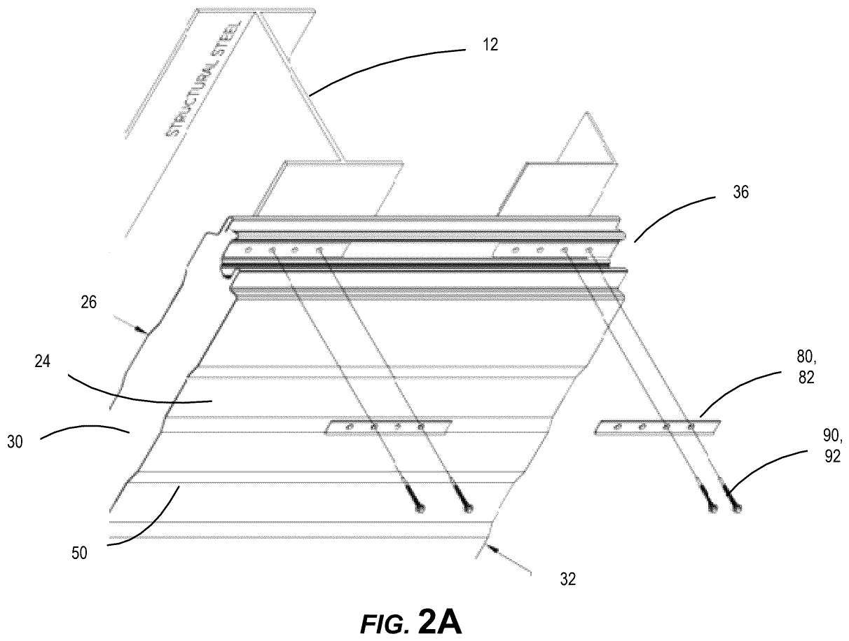

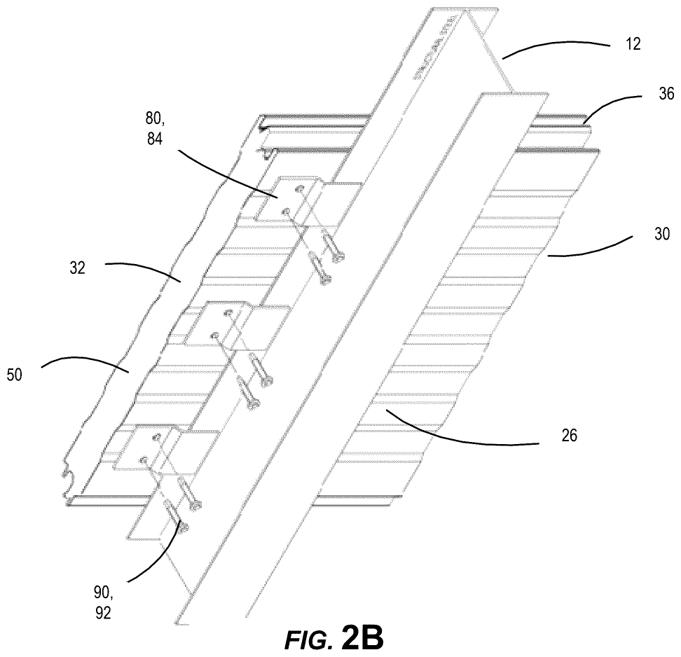

The insulated panels 22 may be operatively coupled to the support members 12 in various ways dependent on the type of panel, weight of the panel, edges 34, 36, ends 30, 32, or the like of the insulated panels 22. For example, referring to FIGS. 2A and 2B, the insulated panel 22 may be a heavy gauge panel (e.g., 20, 22, 24, or the like gauge) that is operatively coupled to a support member 12 that is an I-beam or an H-beam. As illustrated in FIGS. 2A and 2B, the insulated panel 22 may be attached through the use of retainer members 80 (e.g., rectangular, square, oval, uniform, non-uniform, z-shaped, s-shaped, or the like members) that may have one or more apertures therein, and/or connectors 90 (e.g., fasteners 92, such as rivets, screws, bolts, nuts, or the like, clamps, clips, or the like connectors). For example, the edge retainer members 82 may be located within a channel on edges 34, 36 of the panels 20 and operatively coupled to the support member 12 using the fasteners 92, such as rivets. For example, in some embodiments the edge retainer members 82 may be used to operatively couple the second edge 36 of the panel to the support member 12 using the fasteners 92. Additionally, face retainer members 84 may be used to operatively couple the support member 12 to second face 26 of the panel 22, as illustrated in FIG. 2B.

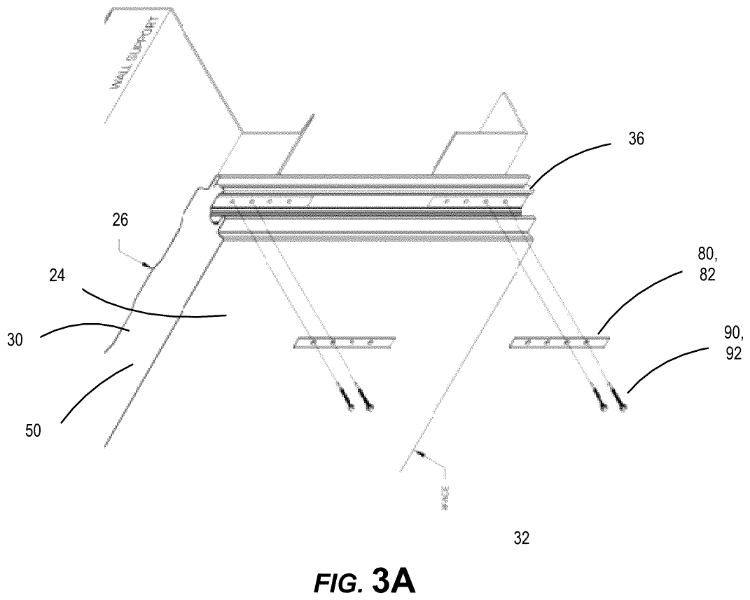

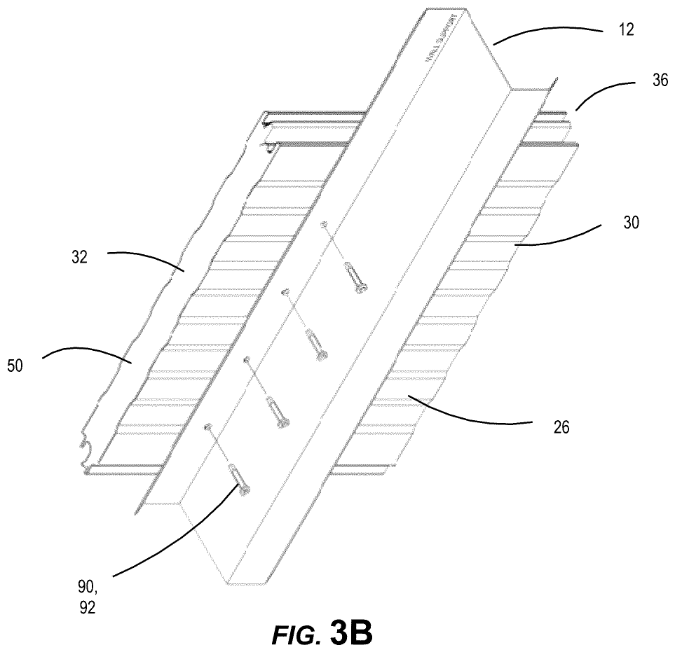

In other examples, referring to FIGS. 3A and 3B, the insulated panel 22 may be a light gauge panel (e.g., 24, 26, 28, or the like gauge) that is operatively coupled a support member 12 that is a z-shaped wall support. As illustrated in FIGS. 3A and 3B, like the insulated panels 22 illustrated in FIGS. 2A and 2B, the insulated panels 22 may be attached through the use of retainer members 80 (e.g., rectangular, square, oval, uniform, non-uniform, z-shaped, s-shaped, or the like members) that may have one or more apertures therein, and/or connectors 90 (e.g., fasteners 92, such as rivets, screws, bolts, nuts, or the like, clamps, clips, or the like connectors). The retainer members 80 may be located within a channel on edges 34, 36 of the panels 20 and operatively coupled to the support member 12 using the fasteners 92. For example, edge retainer members 82 may be located within a channel on edges 34, 36 of the panels 20 and operatively coupled to the support member 12 using the fasteners 92. However, unlike the connection in FIGS. 2A and 2B, the face retainer members 84 may not be necessary, and instead the connectors 90, such as the fasteners 92, may be used to operatively couple the support member 12 directly to the second face 26 of the panel 22, as illustrated in FIG. 3B.

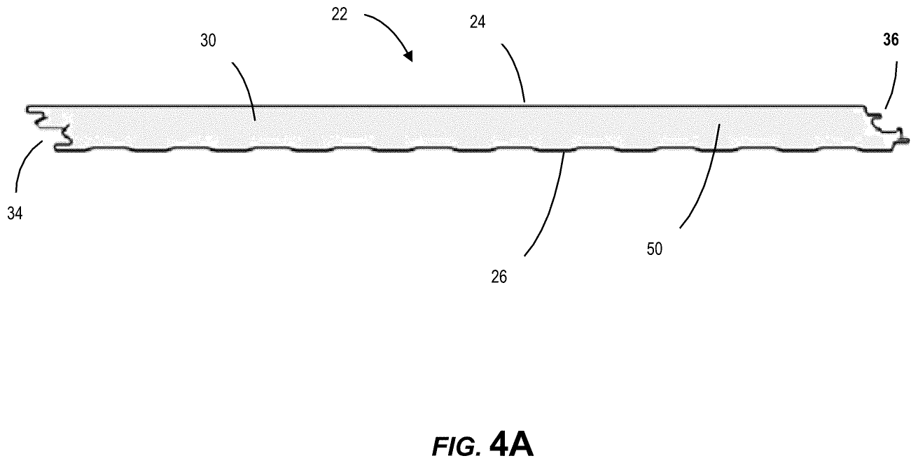

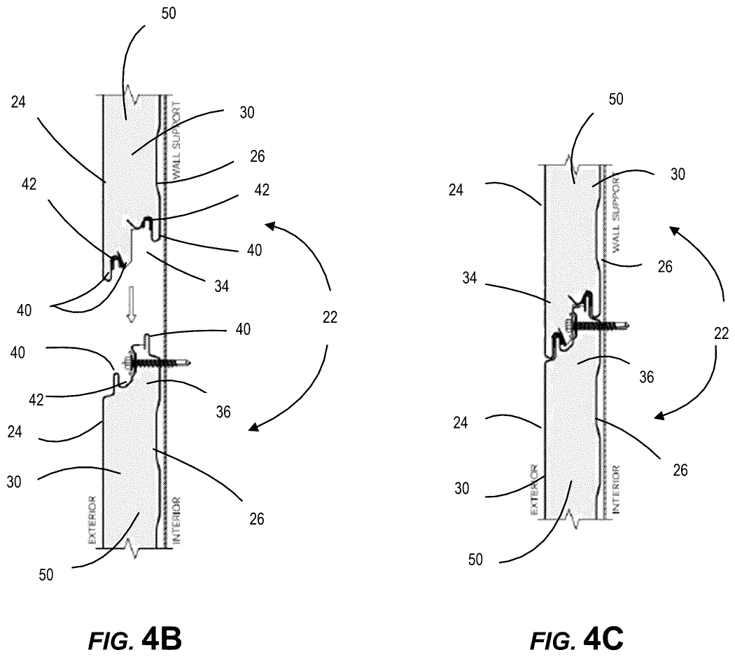

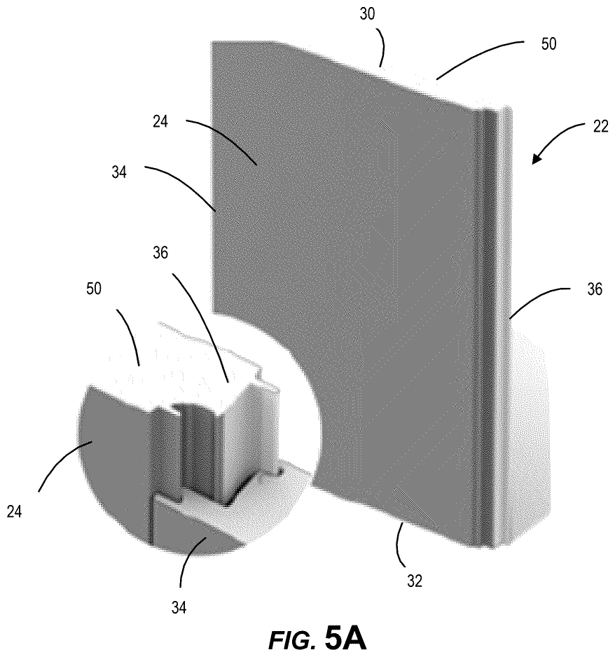

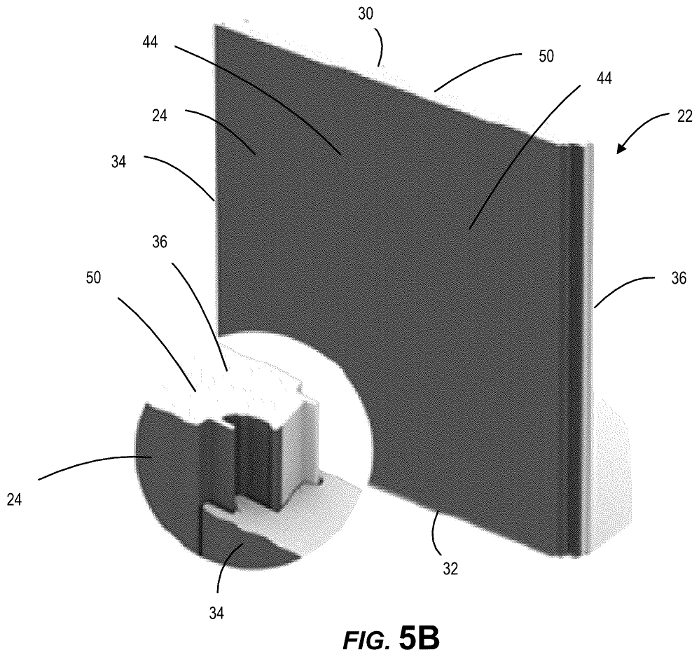

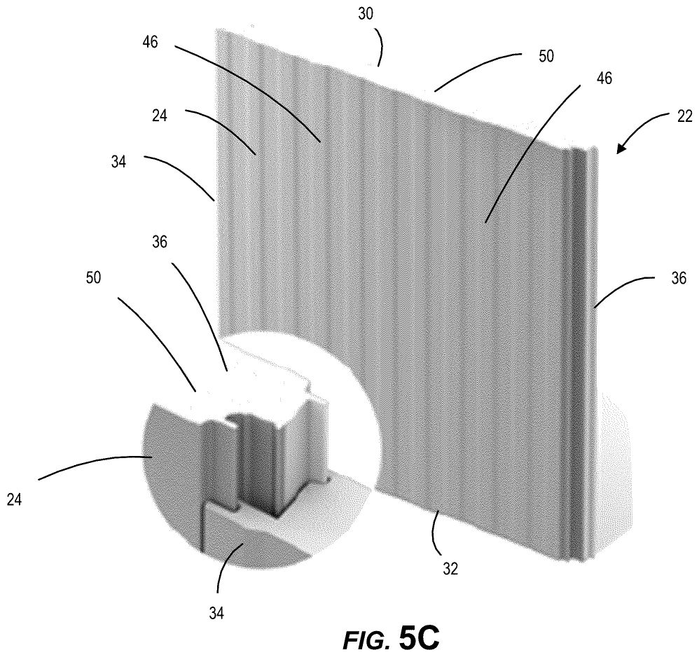

As illustrated in FIGS. 4A through 5C, the plurality of projections 40 and cavities 42 formed from the projections 40 on the first edge 34 of a first panel 22 and a second edge of an adjacent second panel 22 may be used to connect adjacent panels 22. FIG. 5A illustrates one type of insulated panel 22 that may have a first substrate 24 that is flat. Alternatively, FIG. 5B illustrates another type of insulated panel 22 that includes striations 44 in the first substrate 24 (e.g., 1/64, 1/32, 1/16, or the like inches deep, or range between, overlap, or fall outside of these values). FIG. 5C illustrates another type of insulated panel 22 that includes corrugations 46 in the first substrate 24 (e.g., 1/16, ⅛, ¼, or the like inches deep, or range between, overlap, or fall outside of these values). It should be further understood that regardless of whether or not the insulated panels 22 have striations 44 and/or corrugations 46, the insulated panels 22 may be embossed or non-embossed. Furthermore, while the insulated panels 22 are illustrated as being flat, having striations 44, and/or corrugations 46 on the first substrate 24 it should be understood that the second substrate 26 may or may not have these features. Furthermore, it should be understood that the substrates may have different surface shapes, patterns, and/or sizes.

It should be understood that while particular insulated panels 22 are illustrated herein, any type of panel having any type of shape and/or configuration may be used as the insulated panel 22 described herein. The insulated panels 22 may include an insulation material 50 (otherwise described as a foam core, or the like) filling the interior space of the insulated panel 22 and adhesively connecting the facing substrates 24, 26 to provide an insulated panel 22. In particular embodiments, the insulation material 50 comprises a polyol (i.e., polyfunctional alcohols), an isocyanate (e.g., methylene diphenyl diisocyanate, or the like), and/or other materials (e.g., a phase change material (PCM), a catalyst(s), a fire retardant(s), surfactant(s), processing additive(s), blowing agent(s), and/or water, or the like). The polyol and the isocyanate react and form a polyurethane or a polyisocyanurate insulation material 50. The catalysts are used to control the rate of reaction for the manufacturing process by affecting the flow of unexpanded insulation material, the skin formation, and the demolding time. The fire retardants are used to reduce the burn rate and smoke generated by the insulation material 50 during a fire. The surfactants are used to lower the surface tension and promote uniform cell size. The blowing agents, such as pentanes, are used to allow expansion of the insulation material (e.g., 10, 20, 30, 40, 50, or the like times the original unexpanded volume). The water may be used as secondary blowing agent.

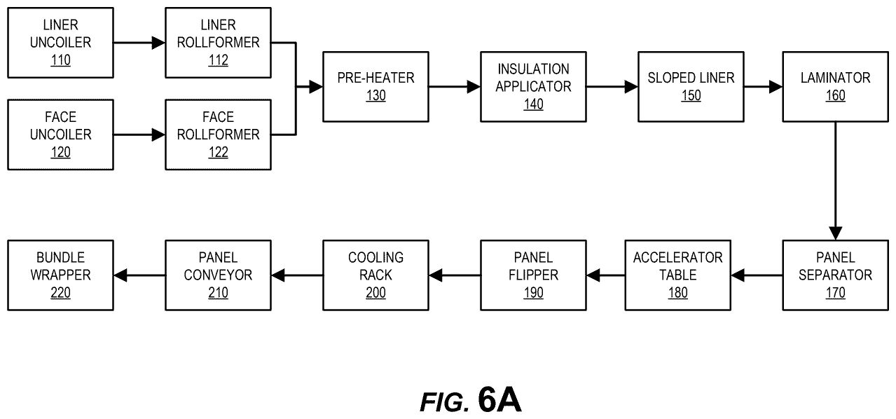

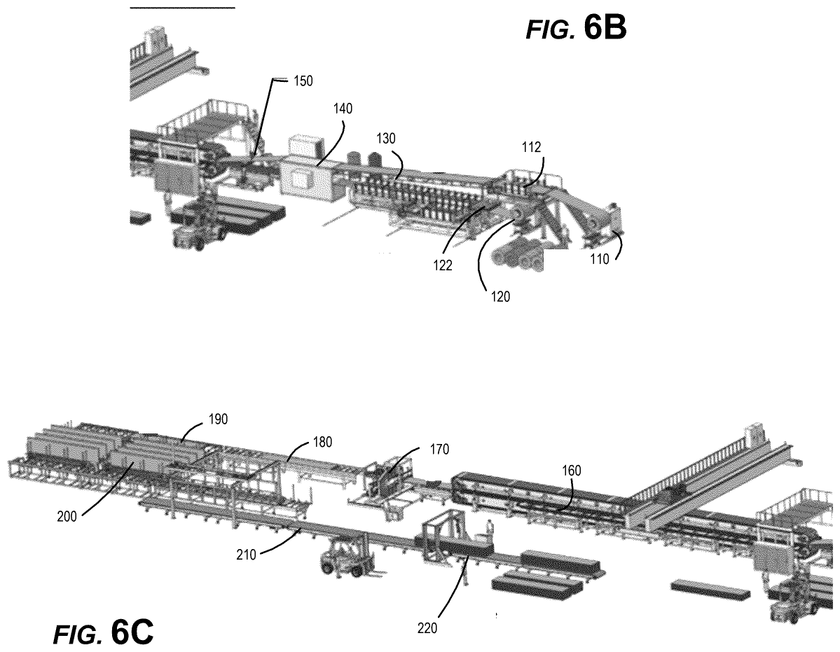

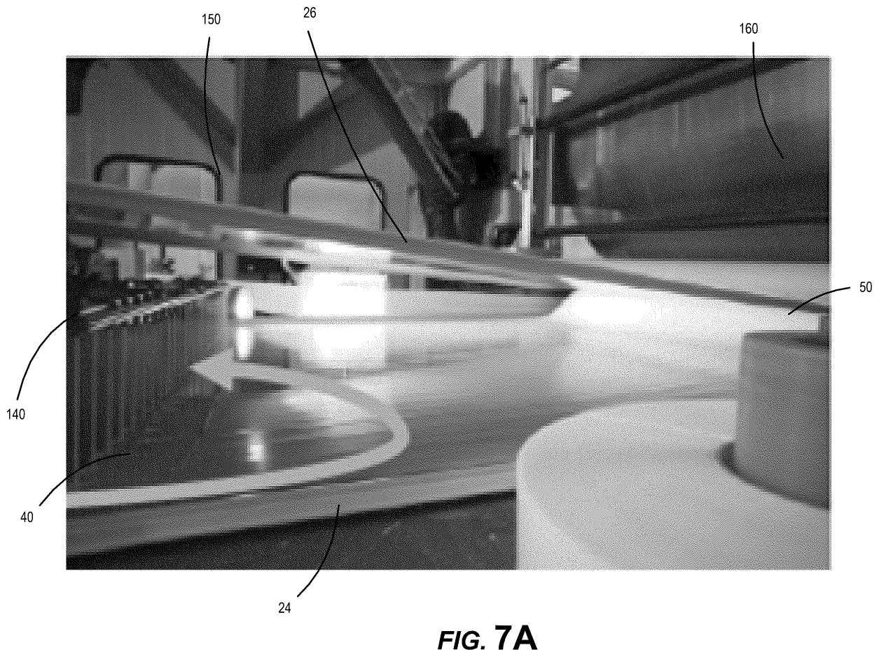

As will be described in further detail herein, the insulation material 50 is applied as an unexpanded material 52 (e.g., a liquid material, a foamed material 54, depending on the equipment being used) and expands and hardens into the insulation materials 50 of the insulated panel 22. It should be understood that the unexpanded material 52 may be utilized in different types of panel forming equipment and/or processes. However, in particular embodiments the processing equipment may be continuous processing equipment. FIGS. 6A through 6C illustrates one type of insulated panel processing equipment 100 and process of manufacturing the insulated panels 22 using continuous panel manufacturing equipment. As illustrated, the insulated panel 22 may be formed through the use of an upper uncoiler 210 (e.g., liner uncoiler, or the like), which may uncoil a steel roll and an upper rollformer 212 (e.g., a liner rollformer, or the like) may roll the steel sheet into the desired shape for an upper substrate. Moreover, a lower uncoiler 220 (e.g., face uncoiler, or the like) may uncoil a steel roll and a lower rollformer 222 (e.g., a face rollformer, or the like) may roll the steel sheet into the desired shape for the lower substrate. It should be understood that the upper equipment and the lower equipment may form either of the first substrate 24 or the second substrate 26 depending on the equipment and process being used.

As further illustrated in FIGS. 6A through 6C, a pre-heater 130 may be utilized in order to heat one or more of the substrates 24, 26 for depositing of the unexpanded insulation 52 (e.g., the liquid insulation 54 or the foam insulation 54) onto one of the substrates 24, 26.

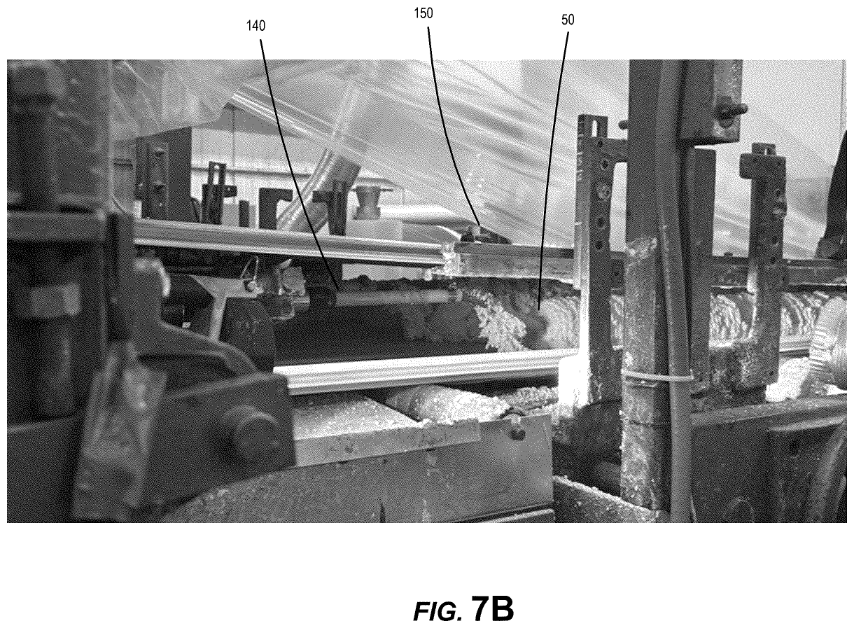

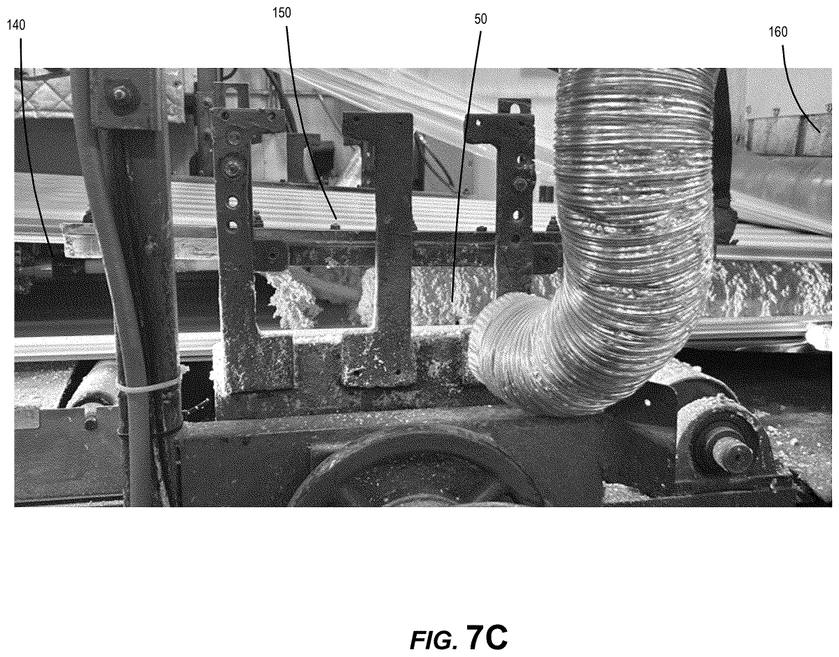

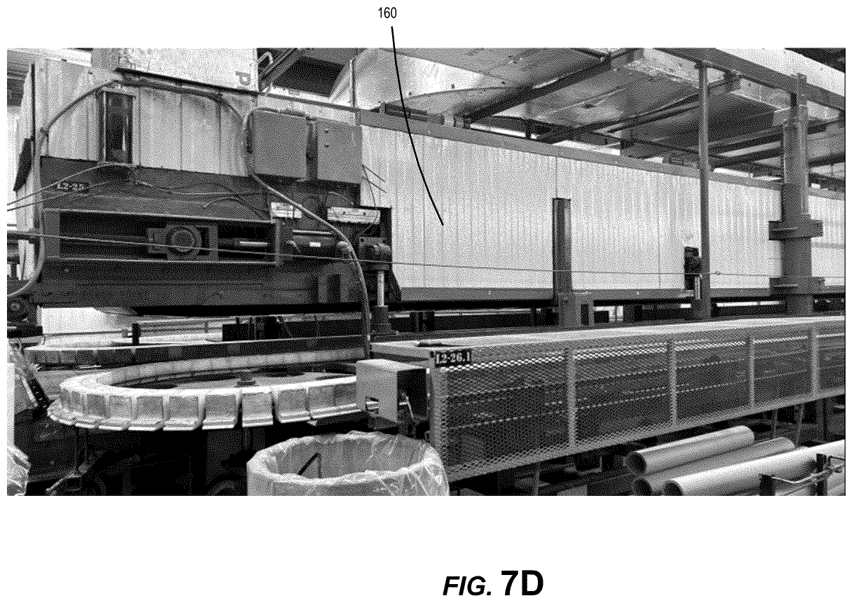

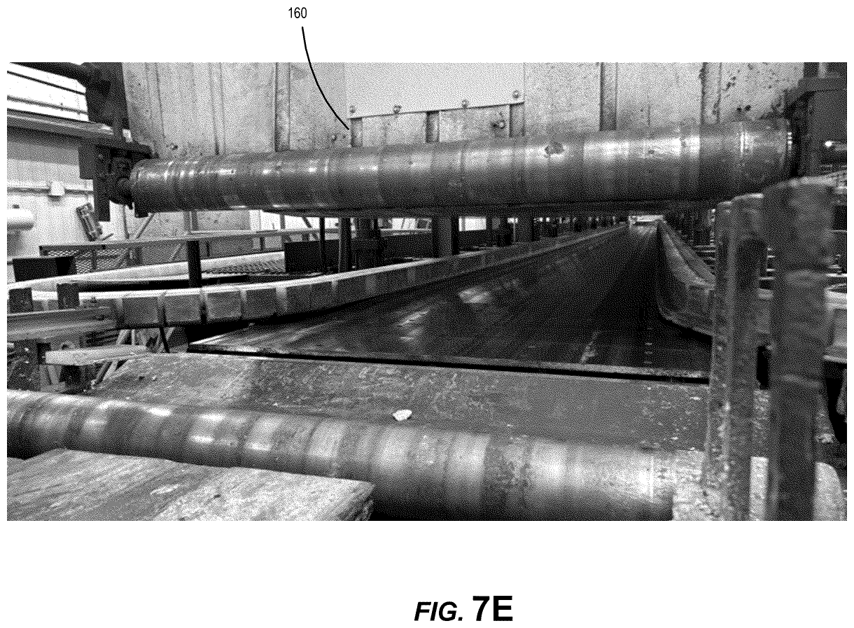

As further illustrated in FIGS. 6A through 6C, the insulation applicator 140 applies the unexpanded insulation material 52 in a liquid form, as illustrated in FIG. 7A, or in a foam form, as illustrated in FIG. 7B. In the illustrated embodiment in FIG. 7A, the insulation applicator 140 comprises of a plurality of liquid dispensing nozzles that are stationary and that deposit the liquid insulation material 52 over at least a portion of one of the substrates, such as the first substrate 24. As the first substrate 24 and the second substrate 26 move down the line toward the laminator 160, which will be described in further detail here, the insulation material begins to expand between first substrate 24 and the second substrate 26. In alternate embodiments, as illustrated in FIG. 7B, the insulation applicator 140 may apply the unexpanded insulation material 52 as expanding foam insulation 54. In this embodiment one, two, three, four, or more, or the like foam nozzles dispense the expanding foam insulation 54 onto on the substrates, such as the first substrate 24. As the first substrate 24 and the second substrate 26 move down the line toward the laminator 160, the insulation material begins to expand between the first substrate 24 and the second substrate 26. As further illustrated in FIGS. 6A through 6C, the sloped liner entry 150 directs the second substrate 26 towards the laminator 160 to be laminated with the expanding insulation material 50 and the first substrate 24.

The laminator 160, as illustrated in FIGS. 6A through 6C, uses heat to laminate the first substrate 24, the expanding insulation material 50, and the second substrate 26 into the insulated panel 22. Moreover, as will be described in further detail herein, the laminator 160 may be used to adjust the adjustable blocks 300 (otherwise described as adjustable molds, or the like) to set the thickness of the insulated panel 22, form the edges 34, 36 of the insulated panel 22 (e.g., form the projections 40 and the cavities 42 formed by the projections 40), and/or restrict the expanding insulation material from foaming outside of the envelope of the insulated panel 22 onto unintended locations of the laminator 160 and/or other equipment.

After the insulated panel 22 is formed, the panel separator 170 (e.g., saw, cutter, blade, knife, laser, plasma, or the like) is used to separate the insulated panel 22 exiting the laminator 160 into the desired lengths, and thus forming the ends 30, 32 of the individual panels 22. After separating, the accelerator table 180 may be used to speed up the movement of the separated insulated panels 22 towards the next station, such as the panel flipper 190, cooling rack 200, and/or other station, where the insulated panels 22 are allowed to fully cure. After the insulated panels 22 have fully cured and cooled, the panel flipper 190 and/or panel conveyor 210 may move the insulated panels 22 toward a bundle wrapper 220 for packaging the insulated panels 22 before they are shipped to the customer.

The insulated panels 22 meet the specifications, such as but not limited to water absorption of less than or equal to 30% (under ASTM C272/AC04); density of greater than or equal to 2.0 lb/ft³ (under ASTM D1622); mass loss of less than or equal to 20% (under ASTM C421); core compression (x) that is greater than or equal to 20 lb/in², core compression (y) that is approximately equal to the core compression (x), and/or core compression (z) that is less than or equal to twice the core compression (x) (under ASTM D1621); tensile adhesion (face) and tensile adhesion (foam) that is greater than or equal to 20 lb/in², and tensile adhesion (liner) that is greater than or equal to 16 lb/in² (under ASTM D1623); thermal conductivity at 75 degrees F. that is less than or equal to 0.140 BTU*in/hr*ft2*degree|R of 7.1 per inch, and thermal conductivity at 35 degrees F. that is less than or equal to 0.112 BTU*in/hr*ft2*degree|R of 7.1 per inch (under ASTM C518); and/or other specification not specifically outlined herein at the time of filing this application or as updated from time to time.

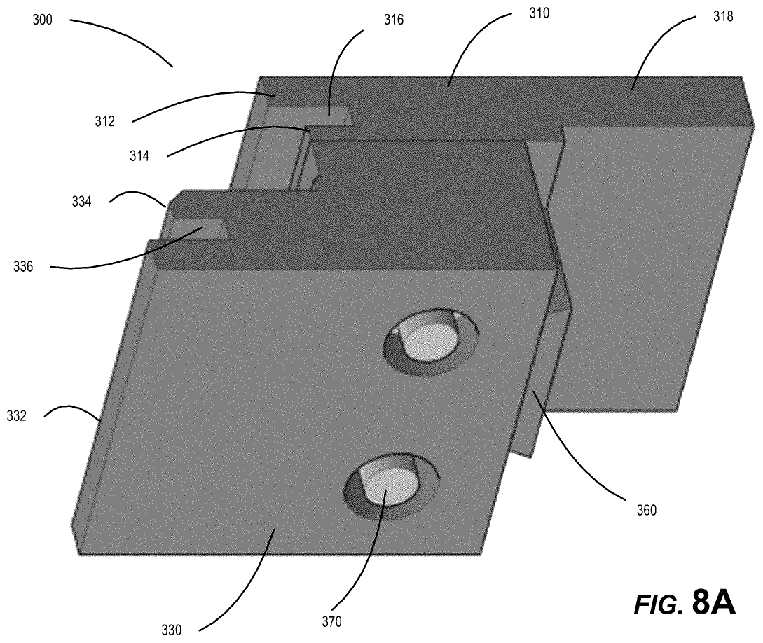

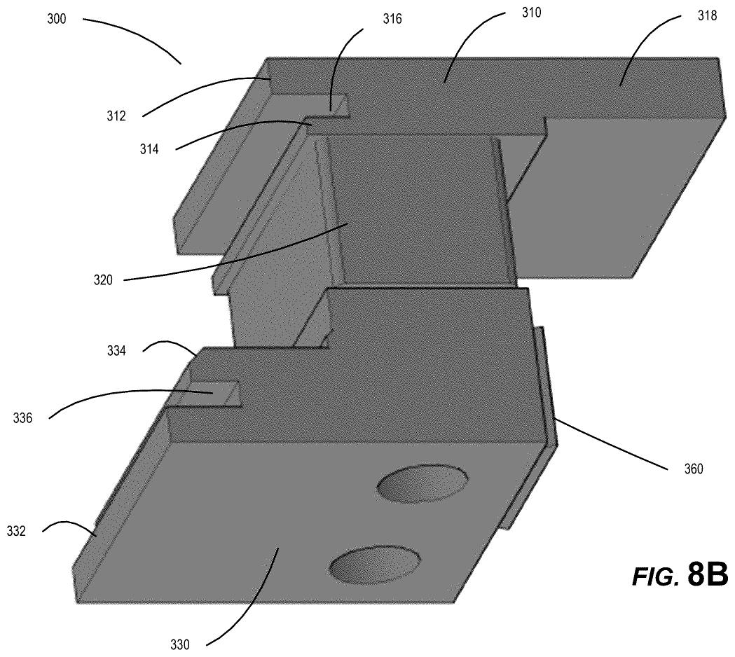

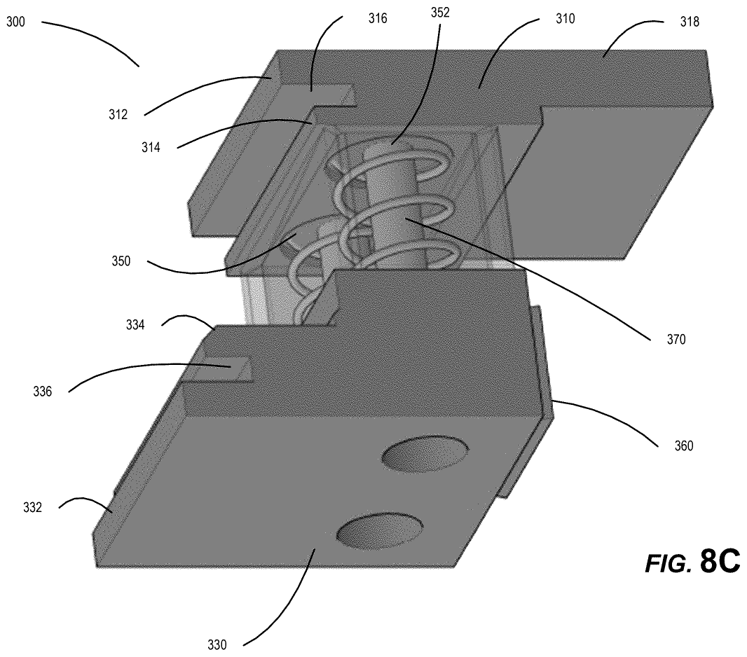

FIGS. 8A through 12 illustrate embodiments of the adjustable block(s) 300, which may be used within the laminator 160, as previously discussed herein, in order to set the thickness of the insulated panels 22 and/or form the edges 34, 36 of the insulated panels 22. As illustrated in FIGS. 8A through 8C, the adjustable block 300 may comprise a first block portion 310 and a second block portion 340, which may be movable with respect to each other through a biasing assembly 370. As illustrated in FIG. 8A, the first block portion 310 and the second block portion 340 may be compressed within the laminator 160 to a fully compressed position, which sets the minimum thickness of the insulated panel 22. Alternatively, as illustrated in FIG. 8B, the first block portion 310 and the second block portion 340 may be expanded to a fully expanded position, which sets the maximum thickness of the insulated panel 22. As will be described in further detail herein, traditional continuous insulated panel processing equipment 100 utilizes static blocks (e.g., otherwise described as static molds), and as such, every time an insulated panel 22 having a different thickness is required, all of the blocks (e.g., illustrated in FIGS. 7D and 7E) must be removed and replaced with other static blocks in order to change the thickness at which the first substrate 24 (e.g., first face, first skin, or the like) and the second substrate 26 are laminated together by the laminator 160. This process of replacing the blocks may take 10, 15, 20, 25, 30 or the like minutes, which increases the amount of time insulated panels 22 may be manufactured depending on the thicknesses of the insulated panels 22 that require manufacturing to meet order deadlines. Unlike traditional systems, the adjustable blocks 300 of the present invention are configured to be adjusted (e.g., changing the height to set the thickness) through the movement of the laminator 160, or components therein, to set the thickness at which the first substate 24 and the second substrate 26 are spaced apart.

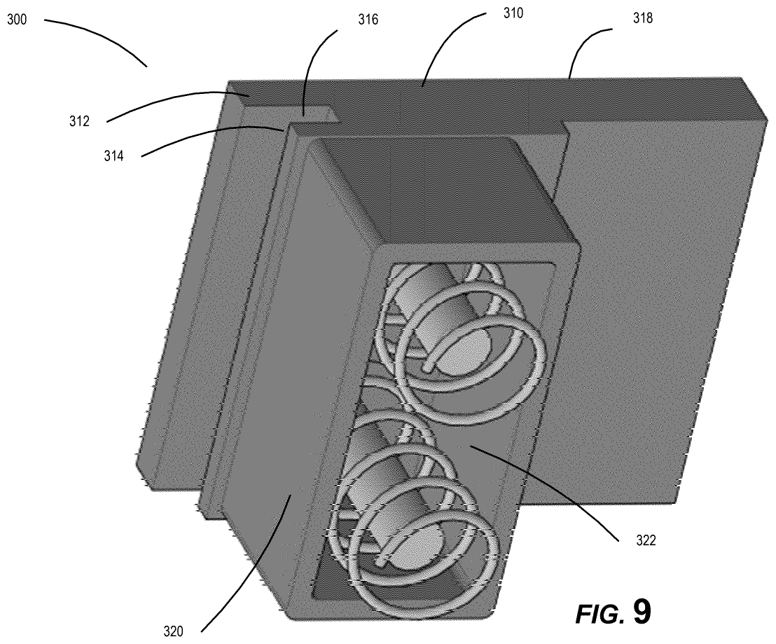

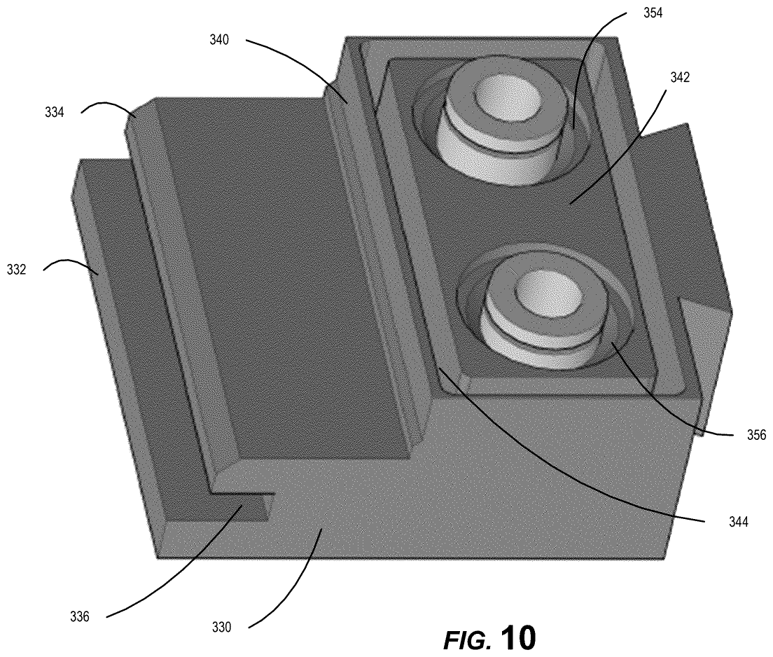

As illustrated in FIG. 9, the first block portion 310 may comprise one or more first block edge projections, such as a primary first block edge projection 314 and a secondary first block edge projection 314, which form a first block edge cavity 316 therebetween. Moreover, as illustrated in FIG. 10, the second block portion 330 may comprise one or more second block edge projections, such as a primary second block edge projection 332 and a secondary second block edge projection 334, which form a second block edge cavity 336 therebetween. The one or more first block edge projections and the one or more second block edge projections are utilized to form at least one edge of an insulated panel 22 (e.g., the projections 40 and/or cavities 42 formed therefrom). In some embodiments, one set of adjustable blocks (e.g., a proximal edge set of adjustable blocks) may be used to form a proximal edge 34 of the insulated panels 22, while another set of adjustable blocks (e.g., a distal edge set of adjustable blocks) may be used to form a distal edge 36 of the insulated panels 22. As such, in some embodiments, the proximal edge set of adjustable blocks and the distal edge set of adjustable blocks may have different block edge projections and/or cavities in order to allow the edges of adjacent insulated panels 22 to be operatively coupled together. Alternatively, the proximal edge set of adjustable blocks and the distal edge set of adjustable blocks may installed in the laminator 160 in opposite orientations such that in one orientation the adjustable blocks form the proximal edge 34 while in the opposite orientation (e.g., rotated 180 degrees) the adjustable blocks form the distal edge 36 of the insulated panel 22. Regardless of the configuration, the adjustable blocks may be used to form the edges 34, 36 of an insulated panel 22 such that the two adjacent insulated panels 22 may be coupled, as previously discussed herein.

As further illustrated in FIGS. 8C through 11C, one or more biasing assemblies 370 may comprise one or more bearings 380 (e.g., a first bearing 382, a second bearing 384, or the like), one or more bearing projections 371 (e.g., a first bearing projection 372, a second bearing projection 374, or the like), and/or one or more biasing members 390 (e.g., a first biasing member 392, a second biasing member 394, or the like). The one or more bearings 380, the one or more bearing projections 371, and/or the one or more biasing members 390 may be operatively coupled to the first block portion 310 or the second block portion 330 to aid in allowing the adjustable blocks 300 to move between a fully compressed position and/or a fully expanded position.

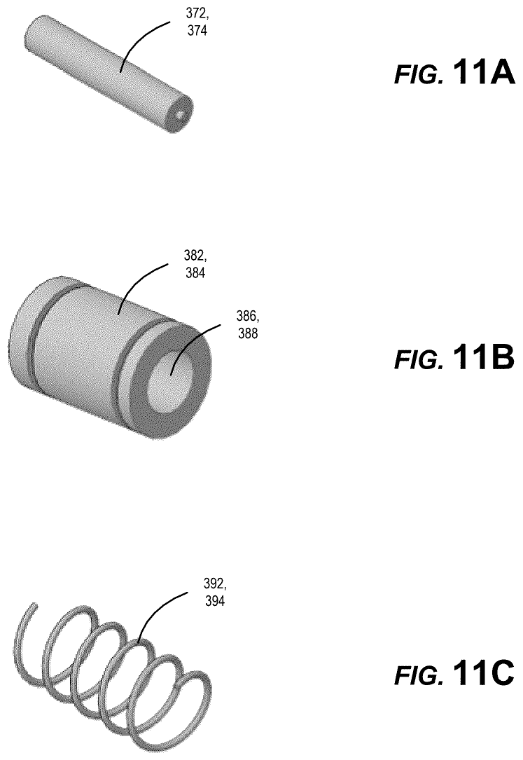

As illustrated in FIG. 11B, the one or more bearings 380 may comprise one or more cylindrical bearings having a bearing aperture 385 (e.g., a first bearing aperture 386, a second bearing aperture 388, or the like) that extends at least partially into the bearing 380, and in some embodiments through the bearing 380. The cylindrical bearing may be configured to receive a bearing projection 371 within the bearing aperture 385. As illustrated in FIG. 11A, the one or more bearing projections 371 may be guide pins that are configured to aid is guiding the adjustability of the first block portion 310 with the second block portion 330 through the use of the biasing assembly 370. As further illustrated in FIG. 11C, the one or more biasing members 390 (e.g., a first biasing member 392, a second biasing member 394), may comprise one or more biasing springs, such as a compression spring. As illustrated in the figures, the one or more bearing projections 371 (e.g., guide pins, or the like) may extend within the one or more bearings 380 (e.g., into the bearing aperture 385), and the one or more biasing members 390 (e.g., compression springs, leaf spring, other spring, or other biasing member) may extend around the one or more bearings 380 and the one or more bearing projections 371.

As illustrated in the figures, the biasing assembly 370 may include a first bearing 382, a first bearing projection 372, and a first biasing member 392 assembled together, and a second bearing 384, a second bearing projection 374, and a second biasing member 394 assembled together. As such, the biasing assembly 370 may include multiple bearing assemblies (e.g., first and second assemblies), which may improve the performance of the adjustable blocks 300 (e.g., durability, operation if one bearing assembly fails, or the like).

While particular embodiments of the biasing assembly 370 may be illustrated in the figures, it should be understood that in other embodiments, not specifically illustrated in the figures, the one or more bearing projections 371 may extend around the one the one or more bearings 380, and/or the one or more biasing members 390 may extend around the one or more bearing projections 371, between the one or more bearings 380 and the one or more bearing projections 371, and/or within the one or more bearings 380. As such, different embodiments of the biasing assembly 370 may be utilized in order to allow the first block portion 310 to move with respect to the second block portion 330.

As further illustrated in FIGS. 9, 11, and 12, the first block portion 310 and/or the second block portion 330 may comprise one or more alignment connectors 302. The one or more alignment connectors 302 may comprise one or more receiving alignment projections 320 which may form one or more receiving alignment cavities 322 in the first block portion 310 or the second block portion (e.g., illustrated in FIG. 9 as being within the first block portion 310). The one or more receiving alignment projections 320 may be a single rectangular projection that forms a single receiving alignment cavity therein, as illustrated in FIG. 9. The one or more alignment connectors 302 may further comprise one or more one or more outer alignment extending projections 340 and one or more inner alignment extending projections 342 in the first block portion 310 or the second block portion (e.g., illustrated in FIG. 10 as being within the second block portion 310). The one or more outer alignment extending projections 340 and the one or more inner alignment extending projections 342 may form one or more extending cavities 344 that are configured to receive the one or more receiving alignment projections 320. The one or more extending alignment cavities 344 may be a single rectangular cavity. The one or more receiving alignment cavities 322 may receive the one or more inner alignment extending projections 342 in a sliding configuration. Moreover, in some embodiments, the one or more outer alignment extending projections 340 may extend around the one or more receiving alignment projections 320.

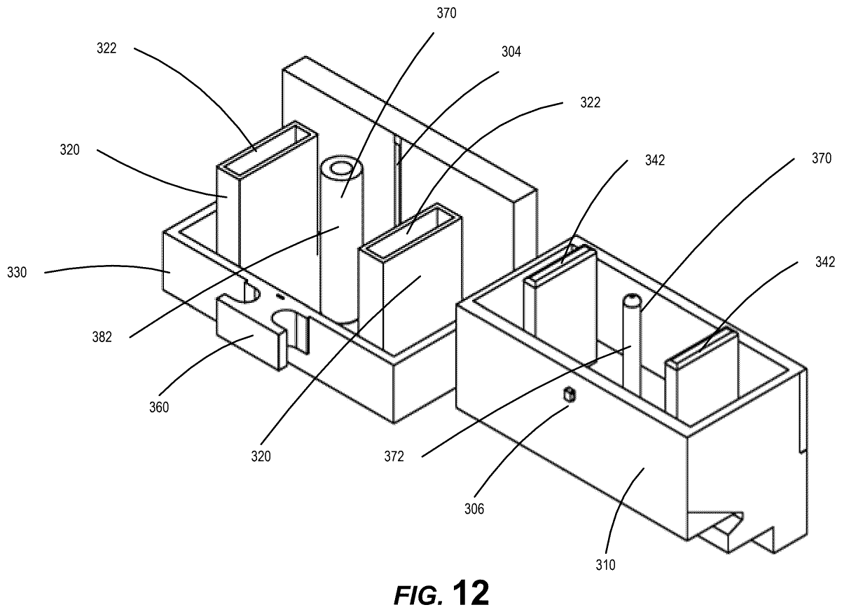

It should be understood that the alignment connectors 302 having the projections and cavities may be any number of projections and/or cavities, and moreover, may have any shape, (e.g., circular, oval, half-circle, square, triangular, any polygonal shape, or the like), size (e.g., correspond with the width of the block, be located within the width of the block, or the like), and/or location (e.g., in one or more surfaces of the first block portion 310 and/or the second block portion 340). For example, in an alternate embodiments, as illustrated in FIG. 12, two alignment connectors 302 may be utilized to help guide the first block portion 310 and the second block portion 330. As illustrated in FIG. 12, the two receiving alignment projections 320 may form two receiving alignment cavities 322 in the first block portion 310 or the second block portion 330 (e.g., illustrated as the second block portion 330 in FIG. 12). The two receiving alignment cavities 322 may receive two alignment extending projections 343 in the opposite of the first block portion 320 or the second block portion 330 (e.g., illustrated as the first block portion 310 in FIG. 12). Regardless of the configuration, the alignment projections and/or cavities may be utilized to aid a first block portion 310 to adjust with a second block portion 340 in order to allow for formation of the insulated panels 22, as described herein.

As further illustrated in FIGS. 8C, 9 and 10, in some embodiments the first block portion 310 (e.g., the receiving alignment cavity 322, or the like) may form one or more first biasing member cavities 350 and/or one or more bearing projection cavities 352 to aid in securing the one or more biasing members 390 (e.g., on a first end) and/or the one or more bearing projections 371 (e.g., on a first end). In further accord with embodiments, the second block portion 330 (e.g., the one or more inner extending alignment projections 342, or the like) may include one or more second biasing member cavities 354 and/or one or more one or more bearing cavities 356 to aid in securing the one or more biasing members 390 (e.g., on a second end) and/or the one or more bearings 380.

It should be understood that while specific cavities are shown within the first block portion 310 and the second block portion 330, other cavities may be formed by the first block portion 310 and/or the second block portion 330 to support the biasing assembly 370. For example, as illustrated in FIG. 12, a single bearing 382 may be coupled to the first block portion 310 or the second block portion 330 (e.g., illustrated as the second block portion 330 in FIG. 12). Moreover, a single bearing projection 372 may be coupled to the first block portion 310 or the second block portion 330 (e.g., illustrated as the first block portion 310 in FIG. 12). The biasing member 390 is not illustrated in FIG. 12, but may the located in, around, or between the single bearing 382 and/or the single bearing projection 372. In still other embodiments, the biasing member 390 may be located within the receiving alignment cavities 322 of FIG. 12.

As further illustrated in FIG. 12, in some embodiments the first block portion 310 and/or the second block portion 330 may have one or more guide channels 304 and/or one or more guide keys 306 located on any surface of the first block portion 310 and/or the second block portion 330. FIG. 12 illustrates the guide channel 304 located on the second block portion 330 and the guide key located on the first block portion 310. However, in other embodiments this configuration may be reversed and/or other configurations may be utilized that have multiple guide channels 304 and/or guide keys 306.

FIGS. 8A-8C, 10, and 12 illustrate a laminator connector 360 that is used to operatively couple the adjustable blocks 300 to a portion of the laminator 160. For example, the laminator connector 360 may be a block key 362 located on the first block portion 310 or the second block portion 330 (e.g., illustrated in the figures on the second block portion 330) that can be operatively coupled to a laminator channel within the laminator 160. As illustrated in FIGS. 7D and 7E, the laminator 160 may comprise edge mold assemblies, such as one or more tracks to which the plurality of adjustable blocks 300 are operatively coupled, a track drive (e.g., motor, actuators, or the like), a track drive train (e.g., gears, pullies, chains, ropes, belts, or the like), or the like components that allow the plurality of adjustable block 300 to rotate and aid in moving the continuous insulated panel through the laminator. In some embodiments, the edge mold assemblies utilize a proximal track and a distal track (e.g., moveable by one or more track drives, track drive trains, or the like). The plurality of adjustable blocks 300 (e.g., a plurality of proximal adjustable blocks and/or a plurality of distal adjustable blocks, or the like) may be operatively coupled to the proximal track and distal track of the laminator 160, respectively, in order to form the edges 34, 36 of the insulated panels 22.

It should be understood that the plurality of adjustable blocks may be utilized to set the thickness of the insulated panel 22 to any range of thicknesses, such as 1, 1.5, 2, 2.5, 3, 3.5, 4, 4.5, 5, 5.5, 6, 6.5, 7, 7.5, 8, 8.5, 9, 9.5, 10, or the like inches (e.g., 2-4 inches, 2-6 inches, 2-6 inches, or the like). As such, the one or more sets of adjustable blocks 300 may be used to cover one or more ranges of these thicknesses. However, it should be understood that the adjustable blocks 300 may be used to set insulated panel 22 thicknesses that range between, overlap, or fall outside of these values.

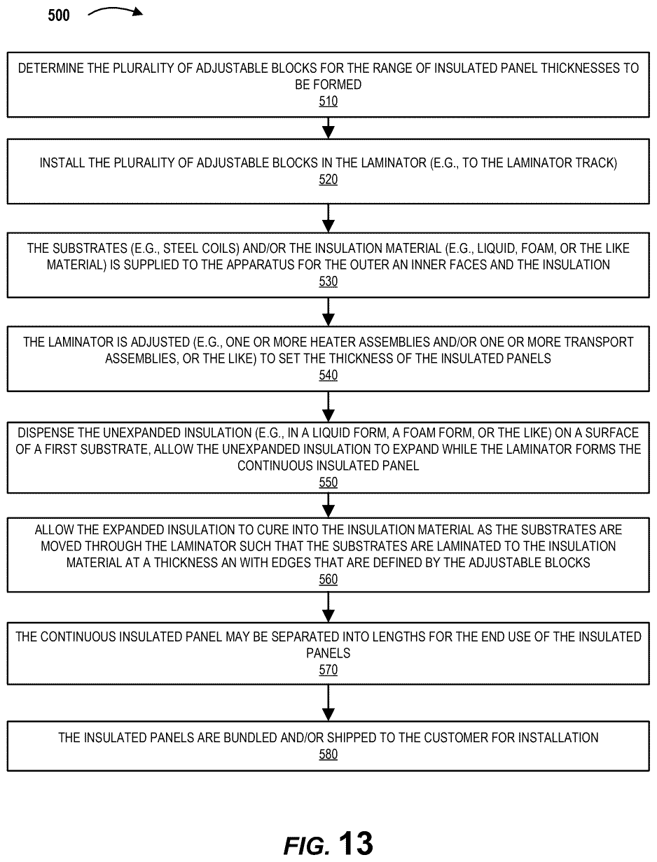

FIG. 13 illustrates a process 500 for utilizing the plurality of adjustable blocks 300 to form insulated panels 22 using a continuous insulated panel manufacturing apparatus 100. As illustrated in block 510 of FIG. 12, in the event different types of adjustable blocks 300 having different ranges of adjustment for the thicknesses of the insulated panels 22 may be used within the continuous insulated panel manufacturing apparatus 100, a determination of the adjustable blocks 300 to use may be made. For example, in the event that panels 22 having a thickness between two (2) and four (4) inches are going to be made, the adjustable blocks having a range between two (2) and (4) may be selected. However, if the panels 22 having a thickness between (3) and six (6) are going to be made, larger adjustable blocks may be used (e.g., adjustable blocks having a range between two (2) and six (6) or two (2) and eight (8) may be used). Additionally, or alternatively, different sets of adjustable blocks 300 with different edge projections may be used to create different edge configurations for the proximal and/or distal edges of the insulated panels 22. As such, the adjustable blocks 300 may be a single set of blocks that can cover all thicknesses and/or edge profiles, and/or different sets of blocks 300 having different ranges of adjustability based on the thicknesses of the panels 22 being used and/or different edge profiles for the insulated panels 22.

FIG. 13 illustrates in block 520 that the plurality of adjustable blocks are installed in the laminator 160. For example, the laminator connector 360 may be coupled to the laminator tracks. In some embodiments the laminator connector 360 is a projection (e.g., dovetail projection, or the like) that slides withing a channel (e.g., dovetail channel, or the like). In other embodiments the channel may be located within the adjustable blocks 300 and the projection may be located on the laminator tracks. The laminator connector 360 may be utilized to or to allow for quick assembly and disassembly of the adjustable blocks 300 to the laminator 160. While particular laminator connectors 360 are illustrated, it should be understood that any type of connector can be used to couple the adjustable blocks 300 to the laminator 360.

FIG. 13 further illustrates in block 530 that the substrates (e.g., from steel coils, or the like) and the unexpanded insulation material 52 for the particular application is supplied to the equipment 100 that is being used to create the insulated panels 22. For example, the coils, the unwinders, and/or the rollers, if the insulated panels 22 would have striations 44 and/or corrugations 46, are determined and/or installed into the equipment 100.

Block 540 of FIG. 13 illustrates that the laminator 160 is adjusted to the desired thickness for the insulated panels 22, which either moves the first block portion 310 and second block portion 330 closer together or farther apart. The laminator 160 may have one or more heater assemblies (e.g., upper, lower, or the like heaters). The one or more heater assemblies may be any type of heater, such as gas-power, electrical powered, or the like, and provide any type of heat to the insulated panel (e.g., convection heating, direct heating, heat exchangers, or any type of heating process). Moreover, the laminator 160 may comprise one more transport assembles, which may comprise one or more substrate transport assemblies (e.g., rollers, conveyors, one or more substrate drives, one or more substrate drive trains, or the like), the one or more edge mold assemblies described above, or the like, in order to move the continuous insulated panel being formed through the laminator 160. For example, the laminator 160 may use the plurality of blocks 300 coupled to the tracks for contacting the edges 34, 36 of the panel 22 (e.g., the track with the blocks rotates to engage and disengage the blocks) and/or one or more conveyors that contact the first substate 24 and/or the second substrate 26 to move the continuous insulated panel through the laminator 160. Moreover, the one or more heater assemblies and/or the one or more transport assemblies may be moved closer together or farther apart through the use of one or more laminator adjustment assemblies (e.g., hydraulic, pneumatic, electromechanical, or the like). That is, the one or more laminator adjustment assemblies may be used to adjust the distance between the one or more heater assemblies and/or the one or more transports assemblies in order to set the thicknesses of the adjustable blocks 300 by moving the first block portion 310 and/or second block portion 330 with respect to each other such that the laminator 160 may set the thickness of the insulated panels 22 and/or heat the substrates and/or insulation material 50 to form the insulated panels 22.

As illustrated in block 550 of FIG. 13, the unexpanded insulation (e.g., in a liquid form or a foam form) is applied on the surface of a first substrate 24 or a second substrate 26, and allowed to expand. As previously discussed herein, the first substrate 24, the insulation material 50, and/or the second substrate 26 may be laminated together in the laminator 160 as the unexpanded insulation is allowed to expand.

FIG. 13 further illustrates in block 560 that the expanded insulation material between the substrates 24, 26 cures as the substrates are moved through the laminator 160 by the transport assembly (e.g., rollers, conveyors, tracks, or the like) such that the substrates 24, 26 are laminated to the insulation material at the thickness set based on the adjustable blocks 300 with the edges that are defined by the adjustable blocks 300.

Block 570 of FIG. 13 further illustrates that in some embodiments, the insulated panel 22 may be separated into the lengths required for the application in which the insulated panel 22 will be installed.

FIG. 13 further illustrates in block 580, multiple insulated panels 22 may be bundled and shipped to the customer for installation onto the building.

The present invention provides improvements over traditional manufacturing that utilizes static blocks. As previously discussed, the traditional manufacturing required replacement of the blocks every time that an insulated panel of a different thickness was required. The process of replacing the static blocks may take 10, 15, 20, 25, 30 or the like minutes, which reduces the amount of time insulated panels 22 may be manufactured. The adjustable blocks 300 of the present invention are configured to be adjusted (e.g., changing the height to set the thickness) through the movement of the laminator 160, or components therein (e.g., support members, or the like), such that insulated panels 22 having different thicknesses may be made without having to change the blocks. The use of the adjustable blocks 300 saves time on the setup of the apparatus, reduces the chance of error when the static blocks are replaced (e.g., improper or incomplete installation, misalignment of the blocks, or the like), and/or allows for improved supply of panels (e.g., different thickness panels may be made in different order to better fulfill panel purchases).

While the present invention has been described with particular reference to the drawings, it should be understood that various modifications could be made without departing from the spirit and scope of the present invention. For instance, while the insulated panels 22 are shown and described as being connected to the support members 12 in a particular way, the panels may be rotated 180 degrees, such that the first edge 34 is the second edge 36 without departing from the spirit and scope of the present invention. Additionally, the entire system may be rotated 90 such that the edges 34, 36 are oriented vertically not horizontally. Furthermore, the adjustable blocks 300 may be utilized for manufacturing other types of panels that are not insulated panels 22.

It should be understood that “operatively coupled,” when used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together.

Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more.”

Certain terminology is used herein for convenience only and is not to be taken as a limiting, unless such terminology is specifically described herein for specific embodiments. For example, words such as “top”, “bottom”, “upper”, “lower”, or the like may merely describe the configurations shown in the figures and described herein for some embodiments of the invention. Indeed, the components may be oriented in any direction and the terminology, therefore, should be understood as encompassing such variations unless specified otherwise. The terminology includes the words specifically mentioned above, derivatives thereof and words of similar import.

While certain exemplary embodiments have been described and shown in the accompanying drawings, it is to be understood that such embodiments are merely illustrative of and not restrictive on the broad invention, and that this invention is not limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A continuous insulated panel manufacturing apparatus, the apparatus comprising:
a first substrate supply assembly configured to supply a first substrate;
a second substrate supply assembly configured to supply a second substrate;
an insulation applicator configured to distribute unexpanded insulation material between the first substrate and the second substrate that expands after distribution between the first substrate and the second substrate;
a laminator assembly comprising:
one or more heater assemblies configured to heat the first substrate, the second substrate and expanded insulation material therebetween;
one or more edge mold assemblies having a plurality of adjustable blocks configured to form edges of an insulated panel; and
one or more laminator adjustment assemblies configured to adjust the plurality of adjustable blocks to set the thickness of the insulated panel.

2. The apparatus of claim 1, wherein an adjustable block of the plurality of adjustable blocks comprise:
a first block portion with one or more first projections;
a second block portion with one or more second projections;
a biasing assembly configured to allow at least one of the first block portion or second block portion to move with respect to the other to adjust the distance between the one or more first projections and the one or more second projections;
wherein the adjustable block is configured to form a portion of a proximal edge or a distal edge of an insulated panel and define a thickness of the insulated panel.

3. The apparatus of claim 2, wherein the biasing assembly comprises:
one or more bearings operatively coupled to the first block portion or the second block portion;
one or more bearing projections operatively coupled to the first block portion or the second block portion; and
one or biasing members operatively coupled to the first block portion, the second block portion, the one or more bearings, or the one or more bearing projections.

4. The adjustable block of claim 3, wherein the one or more biasing members comprise one or more compression springs, wherein the one or more bearing projections comprise one or more guide pins, and wherein the one or more bearings comprise one or more cylindrical bearings.

5. The adjustable block of claim 4, wherein the one or more bearing projections extend within the one or more bearings, and the one or more compression springs extend around the one or more bearings and the one or more bearing projections or wherein the one or more bearing projections extend around the one or more bearings, and the one or more compression springs extend around the one or more bearings and the one or more bearing projections.

6. An adjustable block configured to be used in a continuous insulated panel manufacturing apparatus, the adjustable block comprising:
a first block portion with one or more first edge projections;
a second block portion with one or more second edge projections; and
a biasing assembly configured to allow at least one of the first block portion or second block portion to move with respect to the other to adjust the distance between the one or more first edge projections and the one or more second edge projections;
wherein the adjustable block is configured to form a portion of a proximal edge or a distal edge of an insulated panel and define a thickness of the insulated panel.

7. The adjustable block of claim 6, wherein the biasing assembly comprises:
one or more bearings operatively coupled to the first block portion or the second block portion;
one or more bearing projections operatively coupled to the first block portion or the second block portion; and
one or biasing members operatively coupled to the first block portion, the second block portion, the one or more bearings, or the one or more bearing projections.

8. The adjustable block of claim 7, wherein the one or more biasing members comprise:
one or more compression springs.

9. The adjustable block of claim 7, wherein the one or more bearing projections comprise:
one or more guide pins.

10. The adjustable block of claim 7, wherein the one or more bearings comprise:
one or more cylindrical bearings.

11. The adjustable block of claim 7, wherein one or more bearing projections extend within the one or more bearings, and the one or more biasing members extend around the one or more bearings and the one or more bearing projections.

12. The adjustable block of claim 7, wherein the one or more bearing projections extend around the one or more bearings, and the one or more biasing members extend around the one or more bearings and the one or more bearing projections.

13. The adjustable block of claim 6, wherein the biasing assembly comprise:
two bearings operatively coupled to the first block portion; and
two bearing projections operatively coupled to the second block portion.

14. The adjustable block of claim 6, wherein the biasing assembly comprise:
a first bearing and a first bearing projection operatively coupled to the first block portion; and
a second bearing and a second bearing projection operatively coupled to the second block portion.

15. The adjustable block of claim 6, wherein the first block portion or the second block portion comprise one or more alignment connectors to aid in the adjustment of the first portion with the second block portion.

16. The adjustable block of claim 15, wherein the one or more alignment connectors comprise:
one or more extending alignment projections of the first block portion or the second block portion; and
one or more receiving alignment cavities in the opposite of the first block portion or the second block portion; and
wherein the one or more extending alignment projections slide within the one or more receiving alignment cavities.

17. The adjustable block of claim 6, wherein the one or more first block edge projections of the first block portion comprise:
a primary first block edge projection;
a secondary first block edge projection; and
a first block edge cavity formed from the primary first block edge projection and the secondary first block edge projection.

18. The adjustable block of claim 6, wherein the one or more second block edge projections of the second block portion comprise:
a primary second block edge projection;
a secondary second block edge projection; and
a second block edge cavity formed from the primary second block edge projection and the secondary second block edge projection.

19. A method of forming one or more insulated panels, the method comprising:
distributing unexpanded insulation material between a first substrate and a second substrate that expands between the first substrate and the second substrate;
heating the first substrate, the second substrate, and expanded insulation material therebetween; and
adjusting a plurality of adjustable blocks to form the insulated panel with a thickness based on an adjustment of the plurality of adjustable blocks.

20. The method of claim 19, wherein an adjustable block comprises:
a first block portion with one or more first edge projections;
a second block portion with one or more second edge projections;
a biasing assembly configured to allow at least one of the first block portion or second block portion to move with respect to the other to adjust the distance between the one or more first edge projections and the one or more second edge projections;
wherein the adjustable block is configured to form a portion of a proximal edge or a distal edge of an insulated panel and define the thickness of the insulated panel.
